(19) United States
(12) Patent Application Publication
(10) Pub. No.: US 2024/0142028 A1
(43) Pub. Date: May 2, 2024

(54) PIPE COUPLING PART, AND CORRESPONDING USE

(71) Applicant: Neoperl GmbH, Müllheim (DE)

(72) Inventor: Holger REINHARDT, March/Buchheim (DE)

(73) Assignee: Neoperl GmbH, Müllheim (DE)

(21) Appl. No.: 18/281,003

(22) PCT Filed: Mar. 11, 2022
(86) PCT No.: PCT/EP2022/056373

§ 371 Date: Sep. 8, 2023

(30) Foreign Application Priority Data
Mar. 19, 2021 (DE) 20 2021 101 421.0

(51) Int. Cl. F16L 19/02; F16L 37/14

(52) U.S. Cl. CPC F16L 19/0231; F16L 37/144

(57) ABSTRACT

A pipe coupling part designed to releasably connect a pipe, in particular a flexible hose, to a water conveying system. The pipe coupling part includes a hose nipple that is connected to the pipe or is formed thereon, and a connection part designed to releasably connect the pipe to a mating coupling part in the water-conveying system. The connection part is releasably connected to the hose nipple.

### CROSS-REFERENCE TO RELATED APPLICATIONS

This application is a 371 National Phase of International Application No. PCT/EP2022/056373, filed Mar. 11, 2022, which claims priority to German Patent Application No. 20 2021 101 421.0, filed Mar. 19, 2021, both of which are incorporated herein by reference as if fully set forth.

### TECHNICAL FIELD

The invention relates to a pipe coupling part for releasably connecting a pipe, in particular a flexible hose, to a water conveying system.

### BACKGROUND

Such pipe coupling parts are known, for example, from EP 3 169 853 B1. They are constructed to releasably connect a pipe, for example, a spray hose of a shower, to an additional water conveying system, for example, a spray. To this end, it is necessary for the water conveying system to have a counter-coupling part which is compatible with the pipe coupling part in such a manner that a fluid-tight pipe coupling can be produced. If the pipe coupling part and the counter-coupling part are incompatible, the water conveying system can be connected to the pipe only using an adapter. This requires two pipe couplings, which increases the assembly complexity and material consumption.

### SUMMARY

An object of the invention is to at least reduce these disadvantages.

This object is achieved by a pipe coupling part having one or more of the features disclosed herein. Advantageous embodiments may be taken from the following description and claims.

According to a first aspect of the invention, a pipe coupling part is provided. The pipe coupling part is constructed to releasably connect a pipe, in particular a flexible hose, to a water conveying system. The pipe coupling part has a hose nipple which is connected to the pipe or constructed thereon and a connection part which is configured for releasably connecting the pipe to a counter-coupling part of the water conveying system. The connection part is releasably connected to the hose nipple.

The pipe can, for example, be a pipe which is constructed to transport a fluid, for example, water. As a result of the releasable connection, changing the connection part, for example, in order to connect another water conveying system, is more readily possible. Consequently, the pipe coupling part can be adapted for a greater number of different water conveying systems which are intended to be connected. Changing the entire pipe coupling part or the entire pipe can be avoided. It is possible to provide a modular system, in which a few different types of pipes, for example, of different lengths, can be connected to a relatively large number of different types of connection parts. The types of connection parts can be configured specifically for connections with respect to different counter-coupling parts of the water conveying systems. For example, a large number of shower heads can be connected to a hose. Having to use an additional adapter piece is thereby further avoided, whereby at least one seal is saved. The connection part can be constructed in one or more pieces.

According to one embodiment, the connection part has an intermediate piece which can be releasably connected to the hose nipple. The intermediate piece may, for example, be in the form of a pipe piece which can be connected to the hose nipple of the pipe and the counter-coupling part of the water conveying system with a seal in each case. According to this embodiment, the connection part further has a connection piece, with which the intermediate piece can preferably be connected in a sealing manner to the water conveying system. The connection piece may, for example, be in the form of a bracket which secures the connection between the counter-coupling part and the intermediate piece. Different water conveying systems may be compatible with a pair comprising the intermediate piece and the connection piece. When a water conveying system is changed, it may thereby not be necessary to change the intermediate piece or the connection piece. As a result, the flexibility of the pipe coupling part is increased. The connection and/or intermediate piece can particularly be produced by turning.

According to an additional embodiment, the intermediate piece has a stop for the connection piece. It is thereby possible to construct the connection piece in such a manner that it presses the intermediate piece against the water conveying system with a seal which is connected to the intermediate piece. The seal, for example, an O-ring or a flat seal, can thus be compressed and consequently a fluid-tight connection can be produced. In order to change the connection piece, the intermediate piece can be disassembled, the connection piece changed and subsequently the intermediate piece assembled again. The connection piece and intermediate piece can be exchanged in a similar manner.

According to an additional embodiment, the intermediate piece is rotatably connected to the hose nipple in a connected state. As a result, the water conveying system which can be rigidly connected to the connection piece is nevertheless also rotatably connected to the hose. This increases the flexibility during operation.

According to an additional embodiment, the pipe coupling part further comprises a connection means for releasably connecting the connection part to the hose nipple. The means may, for example, comprise a clamping sleeve or a screw clamp. In an assembled state, for example, a clamping sleeve may be fixed in position in a non-positive locking or positive-locking manner and at the same time provide a bar which connects the hose nipple and the connection part in a positive-locking manner. The hose nipple and intermediate piece are thereby prevented from becoming separated by forces in an axial direction along the pipe by means of positive-locking connection and not only by non-positive locking connection. The axial forces act on the pipe if it is under tension and are typically during operation more powerful than forces which act only on the means for releasable connection.

According to an additional embodiment, the connection means comprises an insertable clamp. As a result, the connection means are simple to assemble. In particular, the insertable clamp may be in such a form that it can be mounted without any tools simply by insertion. During the insertion, the clamp can become resiliently deformed so that it is fixed in position in a positive-locking manner after insertion. When the intermediate piece or the connection piece is changed or in the case of inadvertent incorrect assembly, disassembly and re-assembly thereby become easier. The disassembly can be carried out without tools or with standard tools, for example, a screwdriver.

According to an additional embodiment, the connection means can be inserted or introduced laterally. To this end, for example, the hose nipple and/or the connection part can contain recesses or holes in which the connection means can be pushed. For assembly, the connection part can then initially be brought into the assembled position relative to the hose nipple and subsequently the clamp can be introduced into the recesses or holes. In the assembled position, the clamp then acts as a blocking element which connects the hose nipple and connection part in a positive-locking manner and in particular takes up axial tensile forces. If the recesses are configured particularly deeply in comparison with the lateral extent of the connection part and the hose nipple, it is possible to provide a connection means which extends a long way laterally. As a result, the axial forces can be distributed over a greater cross-sectional surface area so that the stress in the material is low and deformations of the pipe coupling part, and consequently the risk of undesirable disassembly and/or failure of the connection, occur only in the case of tensile forces which are inadmissibly powerful for use.

If the recesses are configured less deeply, the mechanical stress is higher but space-saving construction types are possible.

According to an additional embodiment, the connection part has a sleeve-like union nut or a screw sleeve. A union nut may have an internal thread which can be connected to an external thread on the counter-coupling part of the water conveying system. A screw sleeve can also have an external thread which can be connected to an internal thread on the counter-coupling part.

According to an additional embodiment, the connection piece at least partially covers, at least in a connected state, at least the or an intermediate piece, particularly a portion which projects out of the pipe, and/or the or a connection means. Consequently, the intermediate piece is arranged inside the connection piece, for example, in a screw sleeve. The connection piece may have an inner side which in the connected state is in contact with an outer side of the connection means. The inner side can receive laterally or radially acting forces. If the connection piece covers the connection means, the connection piece must simply be separated from the water conveying system and displaced in order to produce or release the connection of the connection part with respect to the hose nipple. As a result, the connection is protected from unintentional opening.

According to an additional embodiment, the hose nipple is connected to the pipe by a crimp connection. The crimp connection can be produced particularly by the hose nipple being inserted into the pipe and the pipe and hose nipple being joined together. A positive-locking, permanent connection is thereby produced. This connection thereby cannot be inadvertently separated if subsequently the connection part is removed.

According to an additional embodiment, the union nut covers the hose nipple in a connected state. As a result, the hose nipple which is inserted in the pipe and which locally reduces the flexibility of the pipe is recessed in the union nut. The pipe is thereby bendable directly from the start of the nut.

According to an additional embodiment, the pipe coupling part further has a hose nipple sealing element which is constructed to produce a sealing connection between the connection part and the hose nipple. The first sealing element can have an O-ring.

According to an additional embodiment, the hose nipple and/or the connection part further have an annular groove which is constructed to retain the or a hose nipple sealing element.

According to an additional embodiment, the pipe is a flexible hose. Flexible hoses can be produced with little complexity and are suitable for crimp connections.

According to an additional embodiment, the pipe coupling part further has a connection piece sealing element. The connection piece sealing element is constructed to produce a sealing connection between the connection part and the water conveying system. The connection piece sealing element may be fitted in a manner spatially separated from the hose nipple sealing element. Consequently, the hose nipple and the counter-coupling part can have different forms and sizes.

The connection piece sealing element may comprise a flat seal, an O-ring and/or a centering ring. An O-ring can readily be positioned and the connection piece can be rotated more easily relative to the counter-coupling part during assembly. As a result of a centering ring, resilient sealing material, in particular an O-ring, can be fixed in position during assembly. Alternatively, the connection piece sealing element can be fixed in position by an annular groove which is arranged in the connection part or which is formed in the connection part.

According to an additional embodiment, the connection part is constructed to radially press the or a hose nipple sealing element and/or the or a connection piece sealing element in a connected state. It is thereby possible to press the respective sealing element radially onto the connection part and/or another component, for example, the hose nipple, a counter-coupling part of the water conveying system or a centering ring and additionally to axially press it onto a stop or an annular groove of the connection part. As a result, the respective sealing element presses on a great face. Furthermore, the respective sealing element tends to a lesser extent to slip during assembly or disassembly.

According to an additional embodiment, the connection part preferably has a counter-stop for the counter-coupling part at a side opposite the pipe. The hose nipple extends in a connected state axially at most up to the counter-stop. The hose nipple therefore does not project beyond the counter-stop plane and consequently also does not project into the counter-coupling part of the water conveying system. The counter-coupling part of the water conveying system can thereby be sized in a radial direction independently of the dimensions of the hose nipple. For example, an internal diameter of the counter-coupling part and/or water conveying system can be smaller directly from the counter-stop plane of the counter-stop than the external diameter of the hose nipple. The hose nipple is not pushed into the counter-coupling part during assembly and therefore does not have to be sized so as to fit the water conveying system. It is thereby possible to adapt a correspondingly configured connection part, hose nipple and counter-coupling parts and therefore also pipes and water conveying systems of any size and construction type to each other.

According to an additional embodiment, the hose nipple has in a region of the hose nipple sealing element, in particular in a groove base of the annular groove, an extent in a radial direction which is less than or equal to and/or a minimal material thickness which is at most of the same size as that in a region of the connection means. The recesses in which the connection means can be introduced are therefore less deep than the annular groove. Consequently, the hose nipple sealing element can have smaller dimensions in a lateral direction than the connection means. If the hose nipple sealing element is in the form of an O-ring, it can have a smaller diameter than an at least partially annular or semi-annular clamp. If, therefore, during an assembly operation initially the connection part and the hose nipple are positioned relative to each other, excessive deformation and therefore mechanical loading of the hose nipple sealing element are avoided.

According to a second aspect of the invention, there is disclosed a use of a releasable connection on a pipe coupling part, in particular according to the first aspect of the invention, for fixing a connection part to a hose nipple. The use of a releasable connection allows the connection part to be changed, for example, in order to adapt the connection for other water conveying systems. The use can include as the first step positioning the connection part in an assembled position on the hose nipple and, as the second step, positioning a connection means, in particular a bracket.

In one embodiment, the releasable connection is produced after the hose nipple has been connected to the pipe. Connecting the hose nipple to the pipe can be carried out particularly by crimping. All the features and effects of the first aspect of the invention can be transferred to the second aspect of the invention.

### BRIEF DESCRIPTION OF THE DRAWINGS

Exemplary embodiments of the invention are described in greater detail with reference to the appended drawings, in which:

FIG. 1 shows an exploded view of a pipe coupling part according to one embodiment of the invention and a pipe;

FIG. 2A shows an illustration of the pipe coupling part illustrated in FIG. 1 and a pipe, wherein the pipe and a crimp sleeve on the pipe are depicted as a side view and the additional components as a longitudinal section;

FIG. 2B shows a detailed longitudinal section in the region, denoted in FIG. 2A, of the pipe coupling part;

FIG. 3A shows a side view of an intermediate piece according to one embodiment of the invention;

FIG. 3B shows a first perspective view of an intermediate piece according to one embodiment of the invention;

FIG. 3C shows a second perspective view of an intermediate piece according to one embodiment of the invention;

FIG. 4 shows an illustration of a clamp according to one embodiment of the invention;

FIG. 5A shows a side view of a second embodiment of the pipe coupling part and a pipe;

FIG. 5B shows a longitudinal section of the pipe coupling part illustrated in FIG. 5A;

FIG. 6A shows a side view of a third embodiment of the pipe coupling part and a pipe;

FIG. 6B shows a longitudinal section of the pipe coupling part illustrated in FIG. 6A;

FIG. 7A shows a side view of a fourth embodiment of the pipe coupling part and a pipe;

FIG. 7B shows a longitudinal section of the pipe coupling part illustrated in FIG. 7A; and

FIG. 7C shows a plan view of the pipe coupling part illustrated in FIG. 7A.

### DETAILED DESCRIPTION

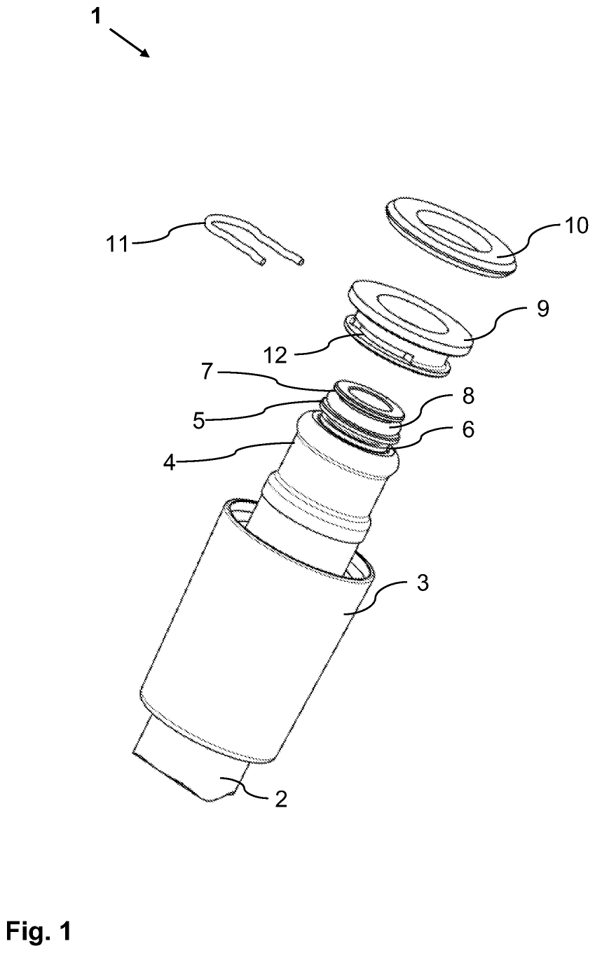

FIG. 1 shows an exploded view of a pipe coupling part 1 according to one embodiment of the invention and a pipe 2. The pipe 2 is in the form of a hose here. The hose nipple 5 is illustrated here in the assembled position. It is already pushed into the pipe 2 and crimped to the pipe 2 by means of the crimp sleeve 4. In this instance, the hose nipple sealing element 8 is in the form of an O-ring and is located in an annular groove which is formed in the hose nipple 5. Furthermore, the hose nipple has a hose nipple recess 6 which is in the form of an annular groove in this instance. In this exemplary embodiment, the connection part has two pieces, that is to say, the connection piece 3 and the intermediate piece 9. The connection piece 3 is in the form of a conically formed screw sleeve and may have an internal thread which can be connected to a counter-coupling part (not shown). The connection piece 3 has been, as illustrated, fitted on the pipe 2 and has been pushed away from the hose end with the hose nipple 5 so far that it is exposed. The smallest internal diameter of the connection piece 3 is greater than the greatest diameter of the pipe 2, crimp sleeve 4, hose nipple 5 and sealing ring 8. Consequently, it can be removed from the hose or can be changed as long as the intermediate piece 9 is separated from the hose nipple 5. The intermediate piece 9 has at least one connection piece recess 12 which is in the form of a continuous slot. For assembly of the connection part, in a first step the intermediate piece 9 can be pushed onto the hose nipple so far that the connection piece recess 12 is axially at the same height as the hose nipple recess 6. The connection means 11 which is in the form of an insertable clamp can be pushed onto the hose nipple recess 6 by the connection piece recess 12 in a second assembly step. The clamp 11 has such dimensions in this instance that the legs of the clamp 11 initially move resiliently slightly apart from each other and subsequently back together during insertion. The clamp 11 is thereby fixed in position in an assembled state and in turn retains the intermediate piece 9 on the hose nipple 5. In a third assembly step, the connection piece sealing element 10 which is in the form of a flat seal here by way of example can be positioned on the intermediate piece 9 and the connection piece 3 can be pushed over the hose nipple 5, the intermediate piece 9 and the sealing elements 8 and 10 in order to connect it to the counter-coupling part, which is not shown, of a water conveying system.

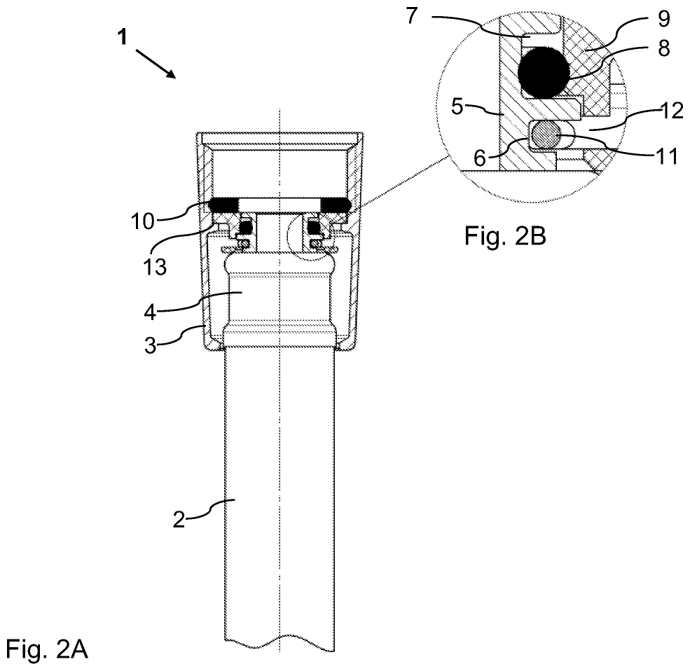

FIG. 2A shows an illustration of the pipe coupling part 1 which is illustrated in FIG. 1 and a pipe 2. The pipe 2 and a crimp sleeve 4 on the line are shown as a side view and the additional components are shown as a longitudinal section. FIG. 2B shows a detailed longitudinal section in the region, which is denoted in FIG. 2A, of the pipe coupling part 1. In this case, the pipe coupling part 1 is shown in an assembled position, but again without the counter-coupling part of the water conveying system. The intermediate piece 9 (cross-hatching) is located at the hose nipple 5. The legs of the clamp 11 are illustrated perpendicularly to the plane of the drawing and are located in the assembled position in the hose nipple recess 6 which is in the form of an annular groove and are illustrated in a state inserted through the connection piece recess 12, which is in the form of a continuous slot, of the intermediate piece. The hose nipple sealing element 8 is depicted as an O-ring with an over-dimension and is compressed in this position in a radial direction. It is located in the annular groove 7 of the hose nipple and seals the intermediate piece 9 and the hose nipple 5. In this exemplary embodiment, the annular groove 7 for the sealing ring 8 is deeper than the hose nipple recess 6 in the hose nipple 5. The hose nipple sealing element 8 is thereby compressed during assembly only when the intermediate piece 9 takes up the mounted position. As a result, the hose nipple sealing element is prevented from being displaced or scratched during the first assembly step. The connection piece 3 is shown in a mounted position and presses at the stop 13 on the intermediate piece 9. The intermediate piece 9 is thereby pressed in the direction of the counter-stop and the connection piece sealing element 10 is compressed. The connection piece sealing element 10 is arranged at a side of the intermediate piece 9 which is opposite the hose. The hose nipple 5 is introduced into the intermediate piece 9 in the assembled position and projects as far as the sealing ring 10. However, the hose nipple 5 does not further project through the connection piece sealing element 10. The shown embodiment can thereby, for example, be connected to a connection pipe with an external thread and counter-stop which has a smaller internal diameter than the hose nipple. The connection piece 3 completely covers the intermediate piece 9 and the crimp sleeve 4, whereby inadvertent disassembly of the connection is prevented.

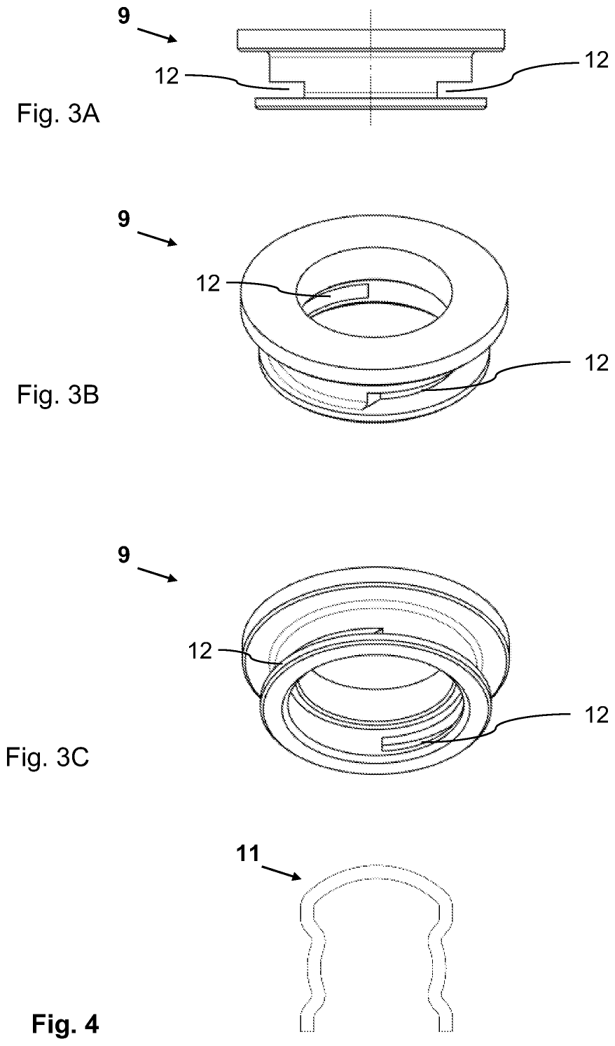

FIG. 3A shows a side view, FIGS. 3B and 3C each show a perspective illustration of an intermediate piece 9 according to one embodiment of the invention.

The intermediate piece 9 is a component of the connection part and has two connection piece recesses 12. The connection piece recesses 12 are continuous and constructed to receive a leg of a clamp.

FIG. 4 shows an illustration of a clamp 11 according to one embodiment of the invention. The clamp 11 constitutes an embodiment of the connection means and has two legs which can be inserted through the connection piece recesses in the hose nipple recesses in order to connect the connection part to the hose nipple. The form of the legs is selected so that the clamp 11 slightly bends apart resiliently during assembly and disassembly. Consequently, the clamp 11 is fixed in position in an assembled state.

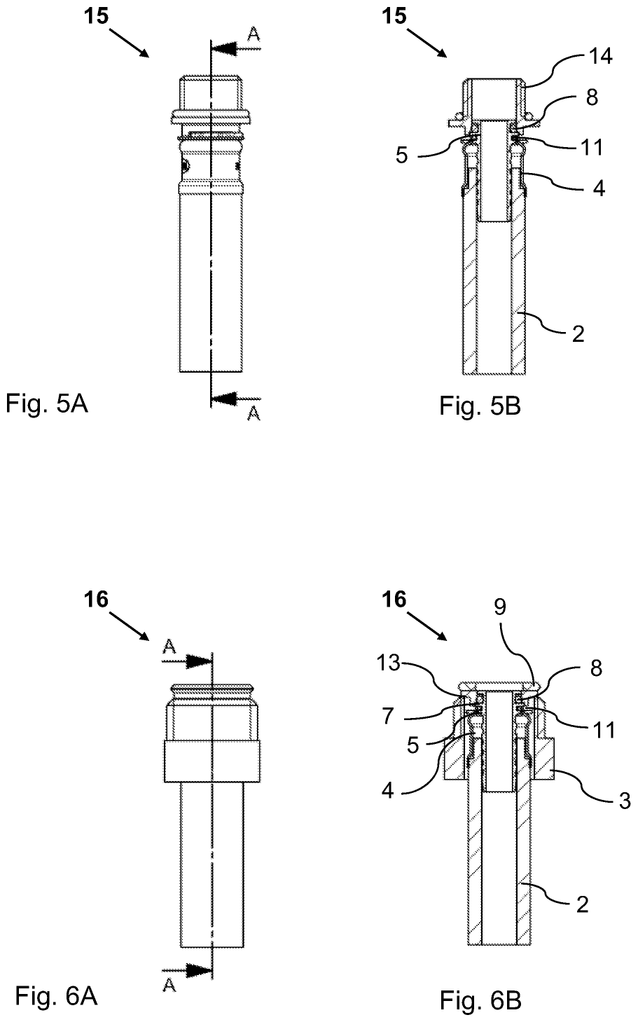

FIG. 5A shows a side view of a second embodiment of the pipe coupling part 15 and a pipe 2. FIG. 5B shows a longitudinal section of the pipe coupling part 15 illustrated in FIG. 5A.

As in the embodiment of FIGS. 1 and 2A-2B, a hose nipple 5 is fitted at one end of the pipe 2 with a crimp sleeve 4.

Unlike the embodiment of FIGS. 1 and 2A-2B, however, this embodiment of the pipe coupling part 15 has a one-piece connection part 14 instead of a connection piece and an intermediate piece. The one-piece connection part 14 is connected to the hose nipple 5 with a connection means which is in the form of a clamp 11. In this embodiment, the connection means 11 is not covered by the connection part 14. Consequently, the connection can be separated and re-produced more easily.

FIG. 6A shows a side view of a third embodiment of the pipe coupling part 16 and a pipe 2. FIG. 6B shows a longitudinal section of the pipe coupling part 16 illustrated in FIG. 6A.

As in the embodiment of FIGS. 1 and 2A-2B, a hose nipple 5 is fitted at one end of the pipe 2 with a crimp sleeve 4. The connection part comprises an intermediate piece 9 and a connection piece 3.

As described above, the intermediate piece 9 is retained by the clamp 11 and sealed by the sealing ring 8 which is guided in the annular groove 7. The connection piece 3 is in the form of a screw sleeve and projects in this case as far as a stop 13 of the intermediate piece 9. The connection piece 3 has an external thread (not shown) which may be compatible with an internal thread of a connection (not shown) in a water conveying system. If, in the embodiment shown, the hose is intended to be connected to another water conveying system with a differently configured connection, it may be simply necessary to change the connection piece 3. To this end, initially the connection to the water conveying system can be released, the clamp 11 removed, the intermediate piece 9 removed, the connection piece 3 removed, a different connection part pushed onto the hose, the intermediate piece 9 mounted again and secured with the clamp 11 and subsequently the other connection part can be connected to the other water conveying system.

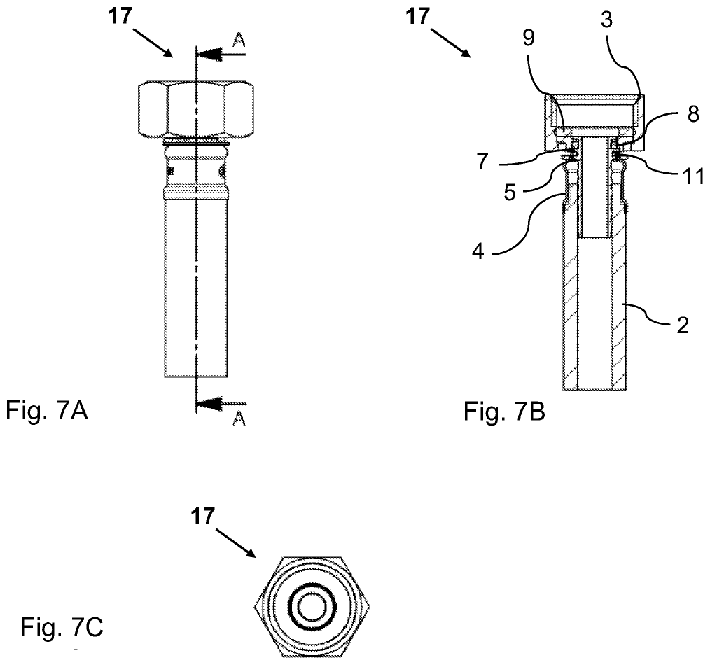

FIG. 7A shows a side view of a fourth embodiment of the pipe coupling part 17 and a pipe. FIG. 7B shows a longitudinal section of the pipe coupling part 17 which is illustrated in FIG. 7A. FIG. 7B shows a plan view of the pipe coupling part 17 which is illustrated in FIG. 7A.

As in the other embodiments shown, a hose nipple 5 is fitted at one end of the pipe 2 with a crimp sleeve 4. The connection part has an intermediate piece 9 and a connection piece 3. The intermediate piece 9 is connected to the hose nipple 5 by the clamp 11 and sealed by the sealing ring 8 which is located in the annular groove 7. The connection piece 3 is in the form of a union nut here. The hexagonal outer contour shown in FIG. 7C shows the shape of the union nut. Unlike the embodiment which is shown in FIGS. 5A and 5B, only the connection piece has to be changed here in order to adapt the pipe to a water conveying system. The intermediate piece 9 does not, however, have to be changed.

There is described and disclosed above a pipe coupling part which is constructed to releasably connect a pipe, in particular a flexible hose, to a water conveying system. The pipe coupling part comprises a hose nipple which is connected to the pipe or is constructed thereon and a connection part which is configured for releasable connection of the pipe to a counter-coupling part of the water conveying system. The connection part is releasably connected to the hose nipple.

### LIST OF REFERENCE NUMERALS

1 Pipe coupling part
2 Pipe
3 Connection piece
4 Crimp sleeve
5 Hose nipple
6 Hose nipple recess
7 Annular groove
8 Hose nipple sealing element
9 Intermediate piece
10 Connection piece sealing element
11 Connection means
12 Connection piece recess
13 Stop
14 Connection part, one piece
15 Second embodiment of the pipe coupling part
16 Third embodiment of the pipe coupling part
17 Fourth embodiment of the pipe coupling part

1. A pipe coupling part for releasably connecting a pipe (2) to a water conveying system, the pipe coupling part comprising:
a hose nipple (5) which is connected to the pipe (2) or constructed thereon; and
a connection part configured for releasably connecting the pipe (2) to a counter-coupling part of the water conveying system; wherein
the connection part is releasably connected to the hose nipple (5).

2. The pipe coupling part as claimed in claim 1, wherein the connection part comprises:
an intermediate piece (9) that is releasably connected to the hose nipple (5), and
a connection piece (3), with which the intermediate piece (9) is connectable in a sealing manner to the water conveying system.

3. The pipe coupling part as claimed in claim 2, wherein the intermediate piece (9) includes a stop (13) for the connection piece (3).

4. The pipe coupling part as claimed in claim 2, wherein the intermediate piece (9) is rotatably connected to the hose nipple (5).

5. The pipe coupling part as claimed in claim 2, further comprising:
a connection means (11) for releasably connecting the connection part to the hose nipple (5).

6. The pipe coupling part as claimed in claim 5, wherein the connection means (11) comprises an insertable or introducible clamp.

7. The pipe coupling part as claimed in claim 5, wherein the connection means (11) is insertable laterally.

8. The pipe coupling part as claimed in claim 2, wherein the connection piece (3) has a sleeve-like union nut or a screw sleeve.

9. The pipe coupling part as claimed in claim 5, wherein at least one of a) the connection piece (3) at least partially covers, at least in a connected state, at least the intermediate piece (9), or b) the connection piece (3) covers, at least in a connected state, at least the connection means (11).

10. The pipe coupling part as claimed in claim 1, wherein the hose nipple (5) is connected to the pipe (2) by a crimp connection.

11. The pipe coupling part as claimed claim 10, wherein the connection piece (3) covers at least in a connected state at least one portion, which projects out of the hose, of at least one of the hose nipple (5) or the or a crimp connection.

12. The pipe coupling part as claimed in claim 1, further comprising:
a hose nipple sealing element (8) which is constructed to produce a sealing connection between the connection part and the hose nipple (5).

13. The pipe coupling part as claimed in claim 12, wherein at least one of the hose nipple (5) or the connection part further include an annular groove (7) which is constructed to retain the hose nipple sealing element (8).

14. The pipe coupling part as claimed in claim 1, wherein the pipe (2) is a flexible hose.

15. The pipe coupling part as claimed in claim 1, further comprising a connection piece sealing element (10), that is adapted to produce a sealing connection between the connection part and the water conveying system.

16. The pipe coupling part as claimed in claim 12, wherein the connection part is constructed to radially press the hose nipple sealing element (8) in a connected state.

17. The pipe coupling part as claimed claim 1, wherein the connection part has a counter-stop for the counter-coupling part, and the hose nipple (5) extends in a connected state axially at most up to the counter-stop.

18. The pipe coupling part as claimed in claim 12, wherein the hose nipple (5) has in a region of the hose nipple sealing element (8), an extent in a radial direction which is less than or equal to that in a region of a connection means (11) for releasably connecting the connection part to the hose nipple (5), or a minimal material thickness which is at most of a same size as that in a region of the connection means (11).

19. A method of connecting a pipe, the method comprising:
connecting the pipe to the pipe coupling part as claimed in claim 1, and
releasably connecting the pipe coupling part to a counter-coupling part.

20. The method of claim 19, further comprising, connecting the pipe coupling part to the hose nipple (5).

21. The method of claim 18, wherein the releasable connection is produced after the hose nipple (5) has been connected to the pipe (2).
